(19) United States
(12) Patent Application Publication
(10) Pub. No.: US 2013/0249907 A1
(43) Pub. Date: Sep. 26, 2013

(54) FIDUCIAL SYSTEM TO FACILITATE CO-REGISTRATION AND IMAGE PIXEL CALIBRATION OF MULTIMODAL DATA

(71) Applicants: Stephen Martin Humphries, (US); Katherine Ann Weimer, (US)

(72) Inventors: Stephen Martin Humphries, (US); Katherine Ann Weimer, (US)

(73) Assignee: Medical Modeling Inc., a Colorado Corporaiton

(21) Appl. No.: 13/612,787

(22) Filed: Sep. 12, 2012

Related U.S. Application Data
(60) Provisional application No. 61/533,699, filed on Sep. 12, 2011.

(51) Int. Cl. G06T 7/00

(52) U.S. Cl. CPC G06T 7/0012
USPC 345/420

(57) ABSTRACT

Methods and systems for facilitating combined co-registration and image pixel calibration of multimodal data are provided. According to one embodiment, a first set of digital image data is received that includes pixel data associated with a portion of a patient's anatomy and a fiducial system. A second set of digital image data is received that includes pixel data associated with the portion of the patient's anatomy and the fiducial system. One or both of the sets of digital image data are adjusted, calibrated, modified or verified based on known characteristics of the fiducial system. A composite model of the portion of the patient's anatomy is generated by co-registering the two sets of digital image data based on the pixel data associated with the fiducial system.

### CROSS-REFERENCE TO RELATED APPLICATIONS

This application claims the benefit of priority of U.S. Provisional Patent Application No. 61/533,699, filed Sep. 12, 2011, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2011-2012, Medical Modeling Inc.

### BACKGROUND

1. Field

Embodiments of the present invention generally relate to fiducial devices. In particular, embodiments of the present invention relate to a fiducial system, including a reference device incorporating fiducial markers, and related automated software methodologies that facilitate creation of composite virtual models from three dimensional scan data produced by different types of devices, computation of a relationship between physical density and image pixel intensity, estimation of imaging device noise model and subsequent image de-noising and scale verification of scanned data.

2. Description of the Related Art

A number of computer-assisted medical treatments, including planning and verification of dental implants and orthognathic surgeries require integration of multiple digital three-dimensional (3D) datasets. Example 3D datasets include medical imaging modalities such as x-ray, multi-detector computed tomography (MDCT), cone beam computed tomography (CBCT) and magnetic resonance imaging (MRI). Other possibilities include digitizing or surface scanning technologies such as laser surface scanning and coordinate measuring machines (CMM).

Alignment or registration (also called co-registration) of different types of 3D data describing the same object (or portions of the same object) in different coordinate referencing systems is a common task in medical imaging and computer assisted design and planning. The often challenging problem is to determine a geometric transformation that best aligns or matches one dataset with another. Typical strategies for registration (i.e. computation of geometric transformation that optimizes alignment) rely on either intrinsic or extrinsic features of the datasets. Intrinsic features are structures inherent to the object scanned, such as anatomy included in a medical tomographic scan or primary features in a laser scanned part. Extrinsic features are artificial features included in the scanning field whose primary purpose is to facilitate registration. Examples of extrinsic features include fiducial markers and stereotactic frames. Identification of known geometry of extrinsic features in each of the datasets to be aligned can provide coordinate values that make it possible to solve for a geometric transformation directly. Such landmark registration methods are known as Procrustes alignment. Other solution strategies such as iterative closest point (ICP) or surface matching approaches do not require specific identification of landmark coordinates, but may perform better with this additional information.

MDCT and CBCT (and some other modalities) are used frequently as the basis for computer assisted pre-procedural planning X-ray computed tomography (CT) modalities such as MDCT and CBCT make use of x-ray attenuation to form images. X-ray attenuation is closely related to material properties such as physical and electron density. It is possible to calibrate CT image pixel values so that images show tissue densities by including an object of well known material properties in the scanning field of view. See, e.g., U.S. Pat. No. 6,990,222. Doing so normalizes image appearance so that pixel data is referenced according the Hounsfield Unit scale, the standard relationship between image pixel value and material density. This is valuable because two different scans (e.g., acquired using different devices or at different times) are more directly comparable. Further, accurate mapping of tissue densities could be useful for treatment planning, normalization of image display or simulation calculations.

CBCT scanning, while increasingly popular and efficient, can present particular challenges. Image quality is reduced compared to MDCT, there is often not a clear correlation between image pixel intensities and physical density and geometric accuracy can be difficult to verify. Each of these factors impacts accuracy of registration to other CBCT scans and laser surface or other digitizing techniques.

A well known limitation of computed tomography (CT), particularly in dental and orthognathic applications, is that teeth and dental occlusion surfaces are not clearly visible due to image resolution (both contrast and spatial) and artifact (e.g. due to metallic dental work or implants). Dental casts and other methods provide a much better representation of dental occlusal surfaces. Techniques for creation of digital 3D models that integrate bony anatomy revealed by MDCT or CBCT with occlusal structure from digitized casts have been proposed and are in use. See, e.g., Jaime Gateno, DDS, MD, et al., “Clinical Feasibility of Computer-Aided Surgical Simulation (CASS) in the Treatment of Complex Cranio-Maxillofacial Deformities,” Journal of Oral and Maxillofacial Surgery, Vol. 64, Issue 4 (2007) pp. 728-734, which is hereby incorporated by reference in its entirety for all purposes. These methods of integration generally rely on fiducial markers for accurate registration. There are a number of key challenges with these techniques: fiducial markers must be clearly imaged by the scanning modalities used (CBCT, laser surface scanning), fiducial markers must remain in a fixed position with respect to key anatomy (teeth, bony anatomy) during each scanning session and in any subsequent use (e.g., registration for surgical navigation), the fiducial marker system and it's components should not disrupt or distort anatomy of interest (e.g. interfere with bite or mandible position or distort soft tissue of the face).

### SUMMARY

Methods and systems are described for facilitating combined co-registration and image pixel calibration of multimodal data. According to one embodiment, a first set of digital image data is received that includes pixel data associated with a portion of a patient's anatomy and a fiducial system. A second set of digital image data is received that includes pixel data associated with the portion of the patient's anatomy and the fiducial system. One or both of the sets of digital image data are adjusted, calibrated, modified or verified based on known characteristics of the fiducial system. A composite model of the portion of the patient's anatomy is generated by co-registering the two sets of digital image data based on the pixel data associated with the fiducial system.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram of an environment within which embodiments of the present invention may be employed.

FIG. 2 conceptually illustrates an intra-oral fiducial marker reference device fixed to a bite impression jig in accordance with an embodiment of the present invention.

FIG. 3 is an example of a computer system with which embodiments of the present invention may be utilized.

FIGS. 4A-C illustrate various views of an exemplary fiducial marker registration device in accordance with an embodiment of the present invention.

FIG. 5A illustrates a laser surface scan of a fiducial marker registration device while engaged with a bottom portion of a corresponding occlusal stone model.

FIG. 5B illustrates a laser surface scan of a fiducial marker registration device while engaged with a top portion of a corresponding occlusal stone model.

FIG. 6A is a sample image of a fiducial marker registration device in a CBCT scan in accordance with an embodiment of the present invention.

FIG. 6B illustrates registration of the sample image of FIG. 6A with representation of a digital stone model in a second scan in accordance with an embodiment of the present invention.

FIG. 7 is a flow diagram illustrating various processing in accordance with an embodiment of the present invention.

FIG. 8 is a plot of Hounsfield Units versus material electron density that may be used in connection with pixel calibration in accordance with an embodiment of the present invention.

### DETAILED DESCRIPTION

Methods and systems are described for facilitating spatial alignment or co-registration combined with image pixel calibration of multi-modality data. As described further below, in one embodiment a novel fiducial system is provided that includes a combination of various of the following features: (i) multiple fiducial markers embedded within a fiducial marker reference device to enable co-registration (alignment) of different scanning/imaging modalities, including but not limited to CT, CBCT, MRI, laser surface scanning, CMM; (ii) the fiducial marker reference device has incorporated therein or can be adapted to receive materials of different density for computation of pixel value to Hounsfield Unit correction; (iii) intra-oral fiducial marker reference device that can be incorporated easily into a bite impression at the time of fabrication of the bite impression using familiar techniques; (iv) the fiducial marker reference device does not alter the bite impression; and (v) the fiducial marker reference device includes landmarks or otherwise has a known scale, thereby enabling verification of scale (and detection of possible distortion) in scanning data, for example, by facilitating measurement of inter-point and inter-landmark distances, measurement of volume and/or measurement of surface area. Depending upon the particular implementation, registration of the different scanning and/or imaging modalities may be accomplished using point, surface and/or voxel based techniques and/or a combination of one or more of the three.

According to one embodiment, a novel fiducial marker reference device, composed of materials whose imaging properties are precisely known, is provided for registration of multi-modal data combined with pixel intensity calibration.

In one embodiment, the fiducial marker reference device incorporates precise geometric shapes and can be sufficiently small to fit into a patient's mouth (for the application of computer-assisted planning of orthognathic surgery, for example). In some embodiments, the fiducial marker reference device fits entirely within a patient's mouth without causing external/skin anatomy distortion and does not substantially altering the patient's bite.

The fiducial marker reference device may be affixed to a bite registration jig, made to record the relationship (bite) between upper and lower teeth. Depending upon the particular implementation, the fiducial marker reference device could consist of plastic and/or ABS materials with embedded aluminum or similar metal where material properties (e.g. electron density) are known. Subcomponents composed of aluminum and/or materials of other distinctly different density can provide reference points and shapes of known dimensions that serve as the means for geometric/scale verification in scan data. In some embodiments, incorporation of several (e.g., 3-5) known density materials (e.g., water equivalent plastic, higher density plastic, such as acrylic, aluminum and/or bone equivalent material) can provide data for image data normalization or Hounsfield Unit calibration.

In one embodiment, the fiducial marker reference device may be used in the context of a fiducial system to facilitate co-registration (spatial alignment) of three dimensional (3D) scan data produced with different types of devices including but not limited to cone beam computed tomography (CBCT), multi detector computed tomography (MDCT), laser surface scanners and coordinate measuring machines. Co-registration enables creation of composite virtual models of internal and external anatomy such as bone, teeth, nerves and soft tissue. Various known methods of co-registration may be used, such as described in Dan Brüllmann et al., “Alignment of cone beam computed tomography data using intra-oral fiducial markers,” Computerized Medical Imaging and Graphics, Vol. 34 (2010) pp. 543-552, which is hereby incorporated by reference in its entirety for all purposes.

As described further below, the fiducial marker reference device may also provide a reference structure of precisely known dimensions that can be used to verify scale recorded in scanning data. In addition, the fiducial marker reference device may incorporate material samples of known density so that a relationship between physical density and pixel intensity (i.e., Hounsfield units) can be computed for CBCT and/or CT data. Various known methods of computing the relationship may be used, such as described in P. Mah et al., “Deriving Hounsfield units using grey levels in cone beam computed tomography,” Dentomaxillofacial Radiology, Vol. 39 (2010), pp. 323-335, which is hereby incorporated by reference in its entirety for all purposes.

In one exemplary usage model, the fiducial marker reference device may be placed intra-orally, affixed to the patient's teeth using a bite jig composed of wax or other material familiar in dentistry, during MDCT or CBCT image acquisition. In a separate process, stone models of the patient's teeth may be fabricated using traditional methods. The stone models of the teeth with the fiducial system fixed in place relative to the teeth utilizing the bite jig are scanned using imaging modalities such as MDCT or CBCT or digitized using a modality such as laser surface scanning or CMM. The appearance of the fiducial system in the digital representations of the patient and of the dental stone models facilitates co-registration of the datasets using point, surface and/or voxel based methods. Further, known properties of the fiducial system enable verification and calibration of the scan and/or image data. Known geometric properties including precisely known linear dimensions and other characteristics such as surface area and/or volume allow verification of the geometric scale of the digitized representation. Known material density (or multiple densities in the case where the fiducial consists of multiple separate material samples) can be used to calibrate image pixels into the typical Hounsfield Unit scale. The fiducial system may also be composed of very homogenous materials so image pixel variations in regions corresponding to a homogenous material can be used to estimate a noise model for a de-noising process.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form. Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection). In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

Brief definitions of terms used throughout this application are given below.

The terms “connected” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

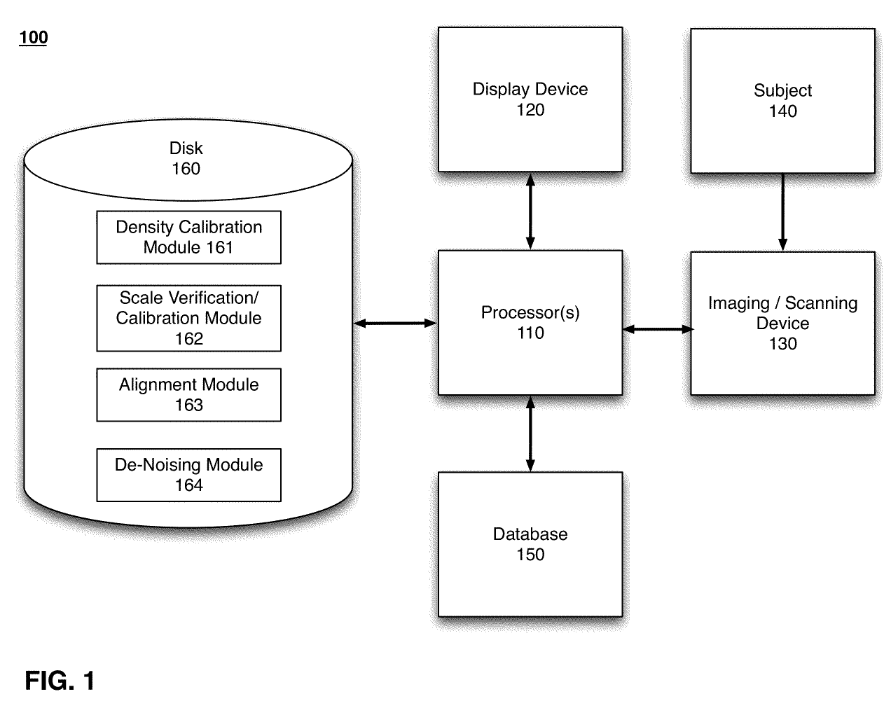

FIG. 1 is a block diagram of an environment 100 within which embodiments of the present invention may be employed. According to the present example, environment 100 includes one or more processors 110 coupled to a mass storage device (e.g., disk 160), a display device 120, a database 150 and an imaging/scanning device 130.

Imaging/scanning device 130 may a device capable of one or more types of scanning modalities, such as x-ray, multi-detector computed tomography (MDCT), cone beam computed tomography (CBCT) and magnetic resonance imaging (MRI). Other possibilities include digitizing or surface scanning technologies such as laser surface scanning and coordinate measuring machines (CMM).

Mass storage device may contain one or more modules that may be used to adjust, calibrate, modify or verify various aspects of scans produced by image/scanning device 130. In one embodiment, the modules may include (i) a density calibration module 161 for calibrating image pixel intensity values of a scan, (ii) a scale verification/calibration module 162 for verifying or adjusting the scale of a scan, (iii) an alignment module 163 for co-registering multiple scans to create a composite model of multiple data sets and (iv) a de-noising module 164 for removing/reducing noise within the scan.

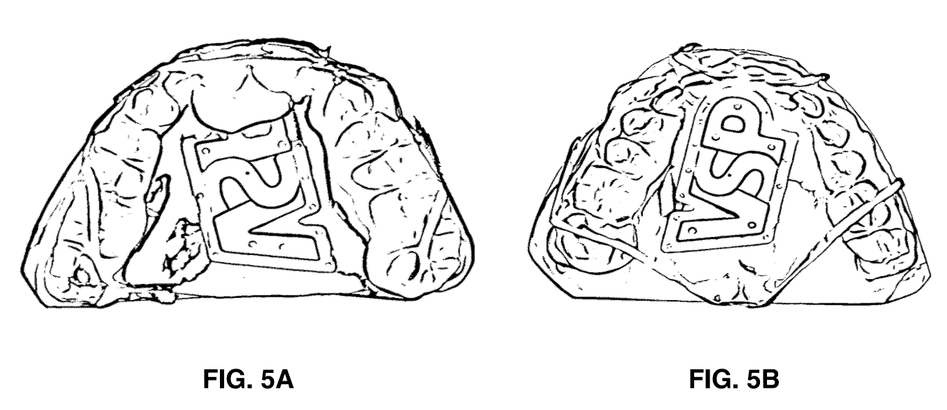

In a scenario in which orthognathic surgery planning is being performed, a fiducial system may be placed intra-orally, affixed to the teeth of a patient (e.g., subject 140) using a bite jig, during MDCT or CBCT image acquisition. In a separate process, stone models of the patient's teeth may be fabricated using traditional methods. The stone models of the teeth with the same fiducial system fixed in place relative to the teeth utilizing the bite jig can be scanned using imaging modalities such as MDCT or CBCT or digitized using a modality such as laser surface scanning or CMM. One or both of the scans, which can be stored in database 150, can then optionally be adjusted, calibrated, modified or verified based on known characteristics of the fiducial system using modules 161, 162, 163 and/or 164, for example. The appearance of the fiducial system in the digital representations of the patient and of the dental stone models facilitates creation of a composite model of the patient's anatomy by co-registering the datasets using point, surface and/or voxel based methods. In some embodiments, virtual surgical planning may be facilitated by displaying the composite model on display device 120 in an interactive form. FIGS. 5A-B illustrate an exemplary laser surface scan of a fiducial marker registration device while engaged with a bottom portion and a top portion of an occlusal stone model.

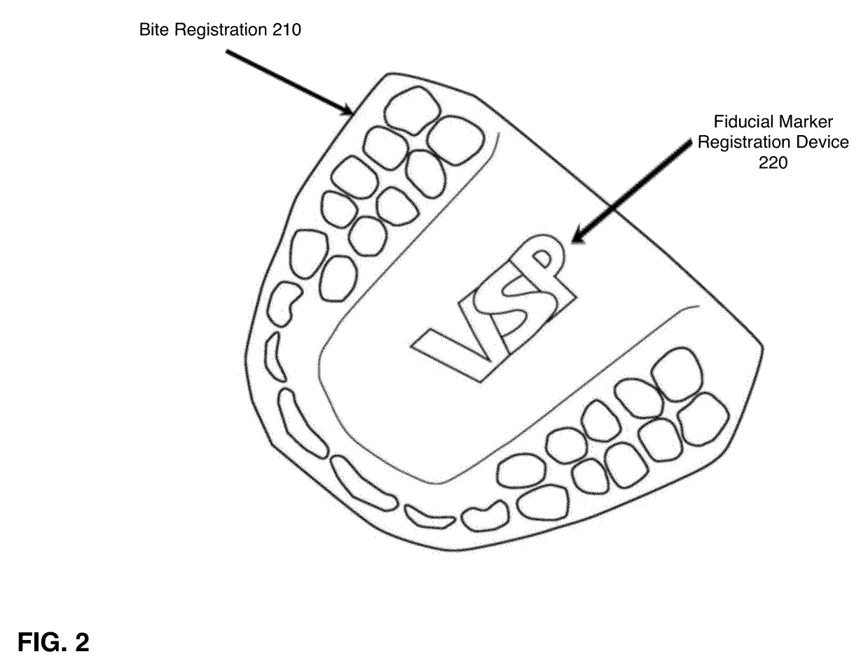

FIG. 2 conceptually illustrates an intra-oral fiducial marker reference device 220 fixed to a bite impression jig 210 in accordance with an embodiment of the present invention. According to the present example, fiducial marker reference device 220 employs (i) a plurality of fiducial makers (not shown) in a precisely known geometry and (ii) reference materials of different density for pixel intensity to physical density calibration. According to one embodiment, the body of the fiducial marker reference device is a radio-opaque material or other material compatible with laser surface scanning

For the application of orthognathic surgery (or other craniomaxillofacial surgeries) and dental implant planning, this fiducial marker reference device may be designed to fit within the mouth (intra-oral) and may be incorporated into a typical bite registration mold, commonly described as a bite jig.

In one embodiment, fiducial marker reference device 220 is composed of radiolucent materials easily imaged using CBCT and may incorporate 3-4 homogenous volumes of different density materials enabling pixel intensity to physical (electron) density calibration and image noise model estimation.

Multiple fiducial markers may be present throughout fiducial marker reference device 220 (e.g., incorporated into the surfaces thereof). Geometric configuration of fiducial markers is well known (and consistent) such that integrity of scale/geometry of the scanned datasets can be verified. Fiducial markers are also configured to be readily visible by the variety of scanning modalities typically used. Registration may be calculated using combinations of point, surface and/or voxel based methods capitalizing on the design features of the new device.

In one potential usage scenario, for the application of orthognathic surgery (or other craniomaxillofacial surgeries) and dental implant planning, fiducial marker reference device 110 can be intra-oral and fixed to bite impression jig 210 or the like and would then be present with the bite impression in the patient's mouth during CT scanning and subsequently on occlusal stone models (if used) during surface scanning Registration of scans (laser surface scans and/or CT) of upper and lower stone models could be performed using point and/or surface methods using fiducial reference features of fiducial marker reference device 220. CBCT scans of the patient with the bite reference 210 and fiducial marker reference device 220 could be registered with scans of stone models. Note in alternative embodiments, bite impression jig 210 with the attached fiducial marker reference device 220 may be scanned directly via an intra-oral scan, for example.

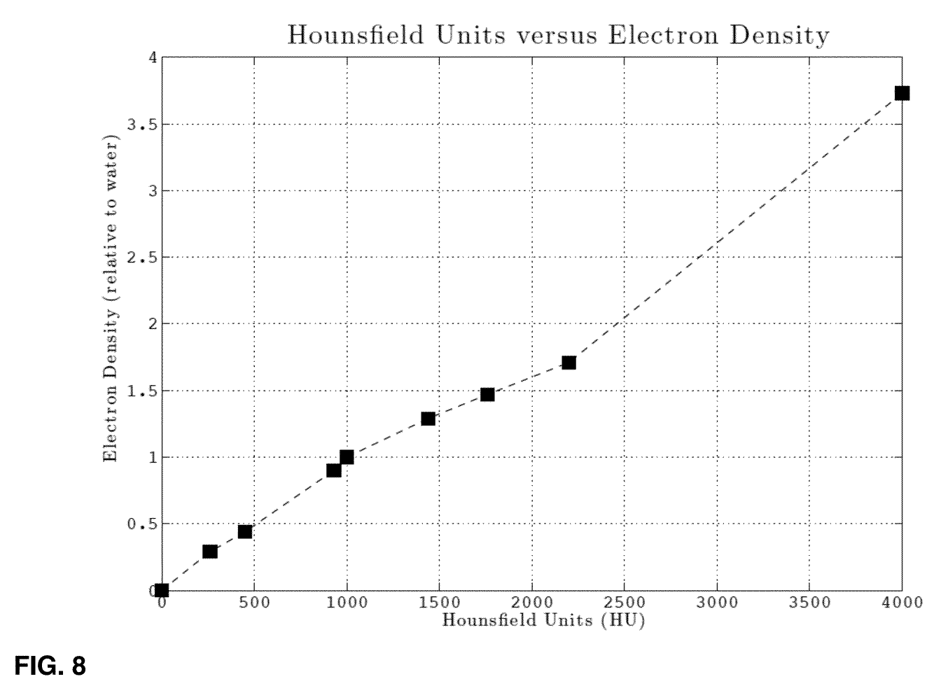

As described earlier, in some embodiments, reference materials of known density may be incorporated within fiducial marker reference device 220 to facilitate generation a pixel value to physical density correction curve (see, e.g., FIG. 8), which enables quantitative comparison of CBCT image data with Hounsfield numbers from MDCT. This also can improve segmentation of bony anatomy since threshold values can be chosen more precisely. Having a known scale associated with the fiducial marker reference device further provides a means for pixel size verification.

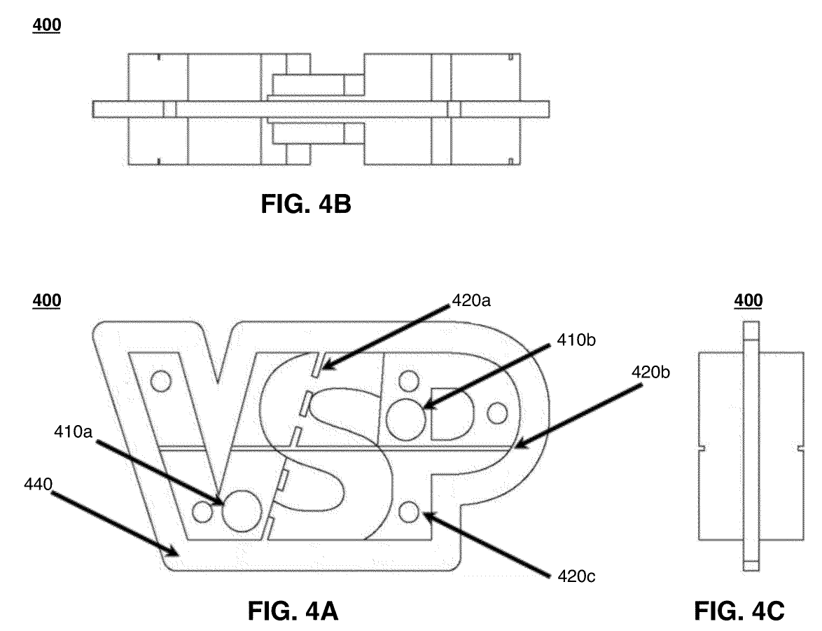

According to one embodiment, the body of the fiducial marker reference device 220 could be made of a single density material. Alternatively, the body could contain multiple density samples (e.g., within cylindrical holes 410a and 410b) for HU calibration as shown in FIG. 4A. Notably, as opposed to prior art teachings suggesting incorporation of metal spheres into a patient-specific holding device, in accordance with embodiments of the present invention, fiducial marker reference device 400 remains the same from patient to patient.

As illustrated by FIGS. 4A-C, the surface of the body of the fiducial marker reference device 400 may have embedded therein multiple (e.g., 3 to 10) fiducial objects (e.g., 420a-c) having the same or differing shapes selected from spheroid, rectangular, conical or other shapes. The fiducial objects could be positive or negative and may be distributed so as to be visible using various scanning methods from top or bottom. The fiducial markers may be asymmetric as depicted in FIGS. 4A-C, which illustrates a non-limiting example of a particular set of fiducial objects having desirable characteristics, such as sharp angles, concave features, convex features, asymmetry, curves and the like.

In one embodiment, means, such as a perforated outer rim 430 may be included within the body of the fiducial marker registration device 400 to facilitate attachment to a bite impression. Preferably, the attachment mechanism will have little to no distortion of imaging scans. For example, in one embodiment, fiducial marker registration device may be attached to a bite impression using wax.

In one embodiment, a primary purpose of fiducial system 400 is to facilitate co-registration (i.e., spatial alignment) of digital scan or imaging data acquired using different modalities. In addition, fiducial system 400 combines a number of characteristics that provide the means to verify and/or calibrate individual scans such as CT, CBCT, laser surface scanning or CMM. Precisely known geometric properties including specific easily identifiable linear dimensions and angles, surface area and volume enable verification of scale in and calibration of digital representations acquired by scanning or imaging modalities including but not limited to CT, CBCT, MRI, laser surface scanning, CMM.

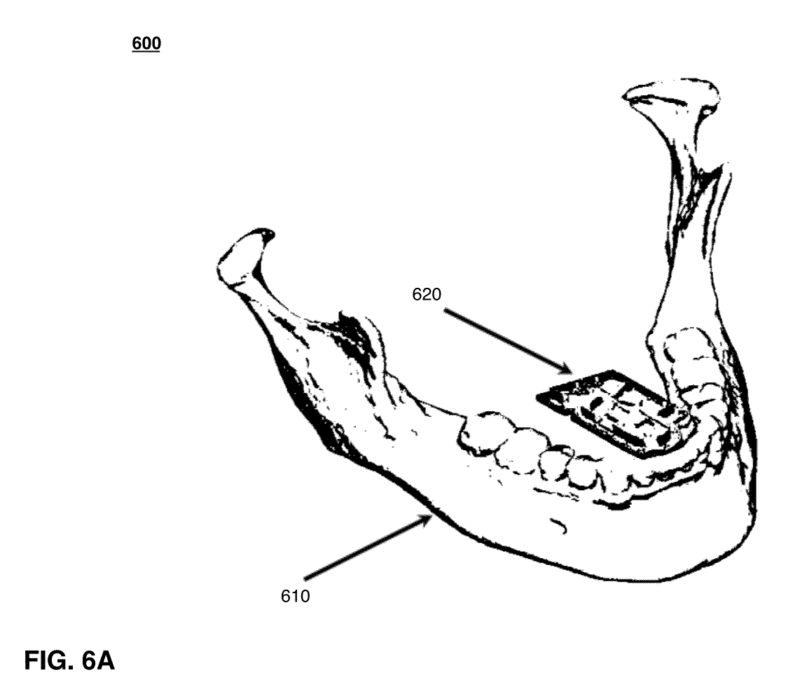

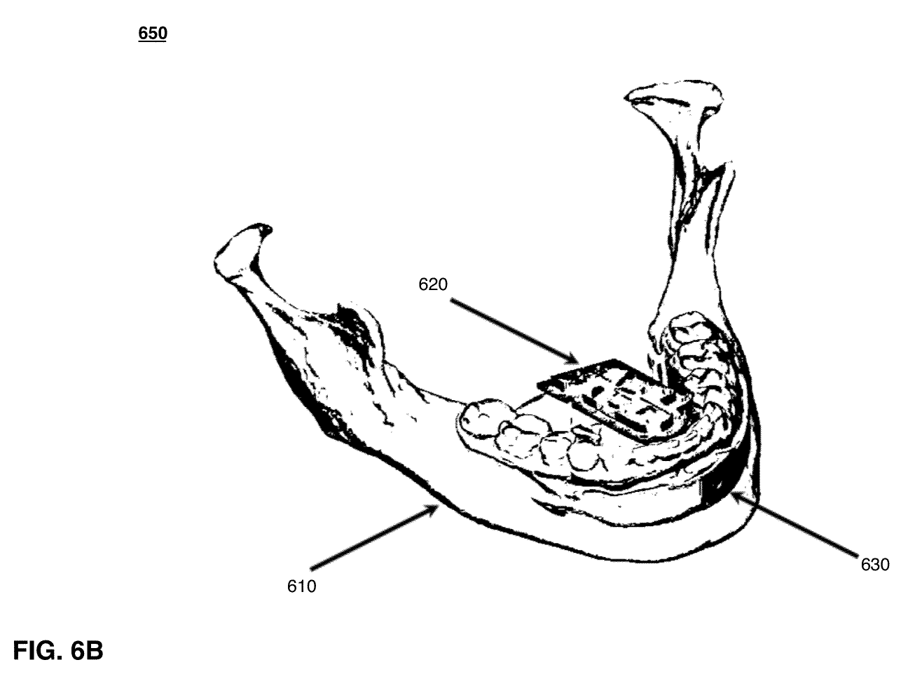

According to one embodiment, registration can be achieved using one or a combination of several different computer-implemented methods including but not limited to paired-point registration where corresponding discrete points are identified in each dataset from which a mathematical transformation is computed, surface-based methods where collections of points describing surface structures are matched generally using iterative methods, or voxel-based methods where multiple image datasets are registered by computation of a mathematical transformation that maximizes a voxel similarity metric between two or more image volumes. FIG. 6A is a sample image 600 of a fiducial marker registration device 620 in a CBCT scan of a patient's anatomy 610 in accordance with an embodiment of the present invention. FIG. 6B illustrates registration of the sample image of FIG. 6A with representation of a digital stone model 630 in a second scan in accordance with an embodiment of the present invention to produce a composite model 650.

Estimation of Hounsfield Units (HU), which are image pixel intensity units related to material density, in CBCT image series can be accomplished in one embodiment as part of a computer-implemented method using measured CBCT image pixel values corresponding to materials of known density. Established linear attention coefficient data for materials of known density can be mathematically fit to this measured data in order to derive an estimate of effective x-ray energy of that CBCT acquisition, thus providing a relationship for estimation of HU. Alternatively, voxel-based image registration of an idealized image dataset (e.g. high resolution scan acquired using a properly calibrated MDCT device) of the fiducial marker, which provides target HU values, can enable direct comparison of corresponding image pixels allowing computation of a transfer function that would correct CBCT image pixels to HU estimates.

Internal and external dimensions, angles, and inter-point distances between key landmarks in the fiducial marker are known precisely. According to one embodiment of the present invention, comparison of known dimensions with distances, dimensions, angles and other parameters measured in digital scan data using software tools allows scale verification. In addition, computer graphic overlay of computer aided design (CAD) data representation of fiducial device onto digital scan of device allows additional means of scale verification and screening of warping or distortions in digital scan.

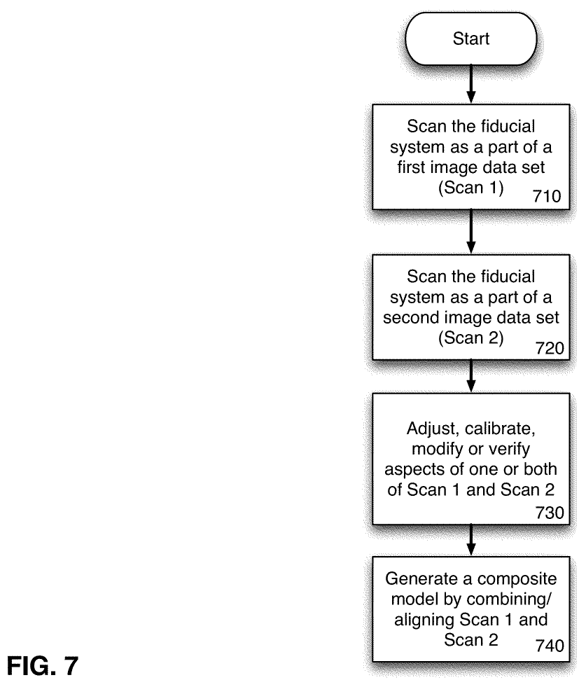

FIG. 7 is a flow diagram illustrating various processing in accordance with an embodiment of the present invention. In the present example, at block 710, a fiducial system is scanned as part of a first image data set (“Scan 1”). See, e.g., FIG. 6A. For example, the fiducial system may be present within the field of view (FOV) of one of several possible scanning modalities including but not limited to CT, CBCT, MRI, laser surface scanning, CMM. Geometric properties (linear dimensions, volume, etc.) of the fiducial system are precisely known. Material properties including physical and electron density and homogeneity of the fiducial system are precisely known.

At block 720, the fiducial system is scanned (potentially using a different imaging/scanning device and/or on a different occasion) as part of a second image data set (“Scan 2”). According to one embodiment, using the same fiducial system as used in Scan 1, a secondary scan can be acquired using one of multiple scanning, imaging or digitizing modalities including but not limited to CT, CBCT, MRI, laser surface scanning, CMM. Depending upon the circumstances, Scan 2 may be acquired at a different time and/or with a different modality than Scan 1, but includes the same fiducial system as represented in Scan 1.

At block 730, aspects of one or both of Scan 1 and Scan 2 may be adjusted, calibrated, modified or verified. According to one embodiment, one or more of modules 161, 162 and 164 may be run against one or both of Scan 1 and Scan 2 to perform density calibration, scale verification or calibration and/or de-noising.

According to one embodiment, the appearance of the fiducial system in Scan 1 can be used for calculation of a relationship between density of the fiducial system and image pixel intensity. This computation can be used to calibrate the image pixel values for all of Scan 1, for example, so that the image pixels are referenced in the HU scale. In accordance with various embodiments of the present invention, the fiducial system is composed of one or more materials whose properties are well known, for example, specially formulated plastics whose electron densities have a known relationship to Hounsfield Units (HU), the standard scale for pixel intensity in CT (see FIG. 8). The fiducial system therefore provides the basis to calibrate image contrast. This can be accomplished by calculating the mathematical transformation necessary to adjust image pixel intensities that correspond to features of the fiducial system whose material properties are known so that that they match standard HU values associated. Thus the appearance of the fiducial system provides reference features that enable adjustment of image pixel values so that they correspond to a known range such as the HU scale. This can be important in modalities such as CBCT which do not generally produce images using the HU scale. Further, the presence of materials of known density in the fiducial system makes it possible be estimate density of surrounding material, for example patient bone density.

In one embodiment, the fiducial system, consisting of homogenous material(s) can be used to estimate a noise model for the imaging system for the purpose of de-noising Scan 1. The fiducial system is composed of materials whose properties are known. The fiducial system composition may be deliberately homogenous (i.e., separate material samples are very homogenous). In an ideal imaging/scanning system (i.e., without noise) the image pixels corresponding to a homogenous material should also be homogenous. In other words, if a sample of a homogenous material was imaged in an ideal noiseless system, the resulting image pixel values should also be homogenous. In reality, imaging/scanning systems are not noiseless, but by analyzing the statistics of pixel intensities corresponding to the fiducial system (which is homogenous and composed of known materials) a model for the image noise in a particular scan can be developed. De-noising of an image once a noise model has been developed can be accomplished for example using methods described by (i) Kim, et al., “Classification of parenchymal abnormality in scleroderma lung using a novel approach to denoise images collected via a multicenter study.” Academic Radiol. 2008 August; 15(8): 1004-1016; and/or (ii) Aujol J F, Gilboa G, Chan T, et al., “Structure-texture image decomposition-modeling, algorithm, and parameter selection.” Int J Comput Vision (1), 111-136, 2006—both of which are hereby incorporated by reference in their entirety for all purposes.

According to one embodiment, the known geometric properties (e.g., linear dimensions, surface area, volume and the like) can be exploited in order to verify and possibly adjust scale of Scan 1. For example, dimensions of the fiducial system in the digital representation of Scan 1 can be compared to known dimensions for verification and possible scale calibration.

At block 740, a composite model is generated by combining/aligning Scan 1 and Scan 2 by running alignment module 163. In one embodiment, co-registration of Scan 1 and Scan 2 is based on the fiducial system using point, surface or voxel based techniques.

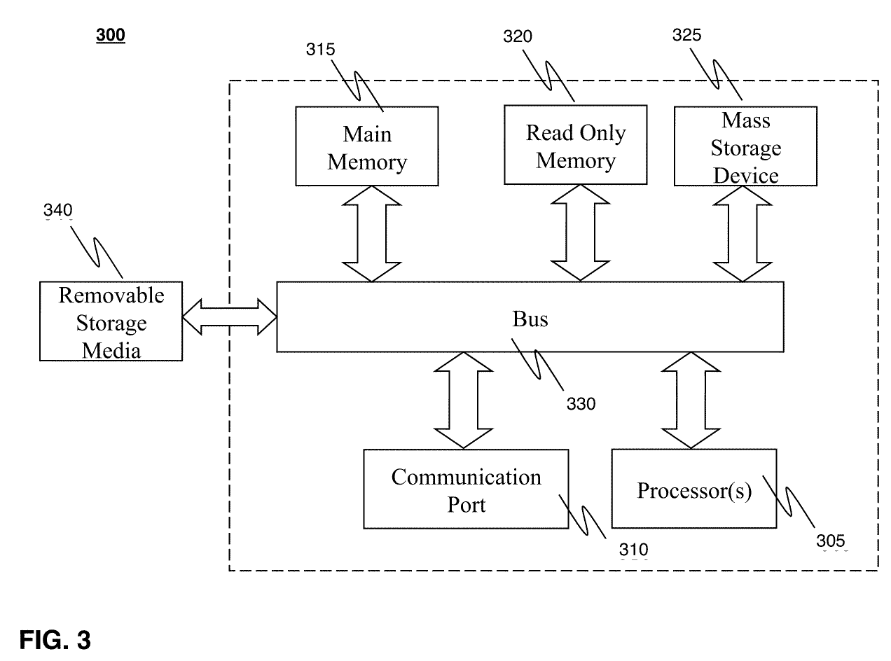

Embodiments of the present invention include various steps, which have been described above. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 3 is an example of a computer system 300, such as a workstation, personal computer, workstation or server, upon which or with which embodiments of the present invention may be utilized.

According to the present example, the computer system includes a bus 330, at least one processor 305, at least one communication port 310, a main memory 315, a removable storage media 340 a read only memory 320, and a mass storage 325.

Processor(s) 305 can be any known processor, such as, but not limited to, an Intel® Itanium® or Itanium 2 processor(s), or AMD® Opteron® or Athlon MP® processor(s), or Motorola® lines of processors. Communication port(s) 310 can be any of an RS-232 port for use with a modem based dialup connection, a 10/100 Ethernet port, or a Gigabit port using copper or fiber. Communication port(s) 310 may be chosen depending on a network such a Local Area Network (LAN), Wide Area Network (WAN), or any network to which the computer system 300 connects.

Main memory 315 can be Random Access Memory (RAM), or any other dynamic storage device(s) commonly known in the art. Read only memory 320 can be any static storage device(s) such as Programmable Read Only Memory (PROM) chips for storing static information such as instructions for processor 305. Mass storage 325 can be used to store information and instructions. For example, hard disks such as the Adaptec® family of SCSI drives, an optical disc, an array of disks such as RAID, such as the Adaptec family of RAID drives, or any other mass storage devices may be used.

Bus 330 communicatively couples processor(s) 305 with the other memory, storage and communication blocks. Bus 330 can be a PCI/PCI-X or SCSI based system bus depending on the storage devices used.

Optionally, operator and administrative interfaces 335, such as a display, keyboard, and a cursor control device, may also be coupled to bus 330 to support direct operator interaction with computer system 300. Other operator and administrative interfaces can be provided through network connections connected through communication ports 310.

Removable storage media 340 can be any kind of external hard-drives, floppy drives, 10MEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only exemplary embodiments.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention.

What is claimed is:

1. A method comprising:
receiving, by a computer system, a first set of digital image data, wherein the first set of digital image data includes pixel data associated with a portion of a patient's anatomy and a fiducial system;
receiving, by the computer system, a second set of digital image data, wherein the second set of digital image data includes pixel data associated with the portion of the patient's anatomy and the fiducial system;
adjusting, calibrating or modifying, by the computer system, at least one of the first set of digital image data and the second set of digital image data based on known characteristics of the fiducial system; and
generating, by the computer system, a composite model of the portion of the patient's anatomy by co-registering the first set of digital image data with the second set of digital image data based on the pixel data associated with the fiducial system.

2. The method of claim 1, wherein the first set of digital image data is acquired by a first scanning, imaging or digitizing modality.

3. The method of claim 2, wherein the first scanning, imaging or digitizing modality comprises x-ray, multi-detector computed tomography (MDCT), cone beam computed tomography (CBCT), magnetic resonance imaging (MRI), laser surface scanning or coordinate measuring machines (CMM).

4. The method of claim 3, wherein the second set of digital image data is acquired by a second scanning, imaging or digitizing modality that is different from the first scanning, imaging or digitizing modality.

5. The method of claim 4, wherein the second scanning, imaging or digitizing modality comprises x-ray, MDCT, CBCT, MRI, laser surface scanning or CMM.

6. The method of claim 5, wherein the first set of digital image data includes a representation of facial bony structure within the portion of the patient's anatomy.

7. The method of claim 3, wherein the second set of digital image data includes a representation of dentition within the portion of the patient's anatomy.

8. The method of claim 7, further comprising facilitating orthognathic surgery planning by displaying the composite model on a display device of the computer system in an interactive form.

9. The method of claim 1, wherein said adjusting, calibrating or modifying comprises:
determining a relationship between a density of the fiducial system and an image pixel intensity; and
calibrating the pixel data of the first set of digital image data based on the relationship.

10. The method of claim 2, wherein the fiducial system is comprised of homogeneous material and wherein said adjusting, calibrating or modifying comprises:
estimating a noise model for the first scanning, imaging or digitizing modality; and
removing noise from the first set of digital image data based on the noise model.

11. The method of claim 1, wherein the known characteristics of the fiducial system include one or more of linear dimensions, surface area and volume and wherein said adjusting, calibrating or modifying comprises calibrating a scale of the first set of digital image data based on the known characteristics of the fiducial system.

12. The method of claim 1, wherein the known characteristics of the fiducial system include one or more of linear dimensions, surface area and volume and wherein the method further comprises verifying a scale of the first set of digital image data based on the known characteristics of the fiducial system.
